(19) United States
(12) Patent Application Publication
(10) Pub. No.: US 2025/0105290 A1
(43) Pub. Date: Mar. 27, 2025

(54) NEGATIVE ACTIVE MATERIAL, NEGATIVE ELECTRODE PLATE, AND BATTERY

(71) Applicant: XIAMEN HITHIUM ENERGY STORAGE TECHNOLOGY CO., LTD., Xiamen (CN)

(72) Inventors: Xiaoqing LIU, Xiamen (CN); Qin ZHANG, Xiamen (CN); Shun LEI, Xiamen (CN); Siqin FAN, Xiamen (CN)

(21) Appl. No.: 18/674,949

(22) Filed: May 27, 2024

(30) Foreign Application Priority Data
Sep. 26, 2023 (CN) 202311258960.3

(51) Int. Cl. H01M 4/587; C01B 32/20; H01M 4/02; H01M 4/133; H01M 10/0525

(52) U.S. Cl. CPC H01M 4/587; C01B 32/20; H01M 4/133; H01M 10/0525; C01P 2006/12; C01P 2006/40; H01M 2004/027

(57) ABSTRACT

Provided are a negative active material, a negative electrode plate, and a battery. The negative active material includes graphite. A specific surface area of the negative active material before a compaction process on the negative active material is X₁. A specific surface area of the negative active material after the compaction process is X₂. An orientation index of the negative active material before the compaction process is OIₐ. The negative active material satisfies 0.05<(X₂−X₁)/OIₐ<0.5, where X₁ and X₂ are in units of m²/g.

### CROSS-REFERENCE TO RELATED APPLICATIONS

This application claims the priority of the Chinese Patent Application No. 202311258960.3, filed on Sep. 26, 2023, which is incorporated herein by reference in its entirety.

### FIELD

The present disclosure relates to the technical field of battery, and particularly, to a negative active material, a negative electrode plate, and a battery.

### BACKGROUND

In the related art, the cycling performance, as an important performance index of the battery, affects the cycling service life of battery. However, during the cycle use of the battery, a cycle performance of the battery deteriorates at a later cycle stage, and thus a cycle capacity retention rate of the battery significantly decreases, thereby affecting a cycle service life of the battery. Therefore, it is urgent to improve the cycling performance.

### SUMMARY

In a first aspect, embodiments of the present disclosure provide a negative active material. The negative active material includes graphite. A specific surface area of the negative active material before a compaction process on the negative active material is X₁. A specific surface area of the negative active material after the compaction process is X₂. An orientation index of the negative active material before the compaction process is OIₐ. The negative active material satisfies 0.05<(X₂−X₁)/OIₐ<0.5, where X₁ and X₂ are in units of m²/g.

In a second aspect, embodiments of the present disclosure provide a negative electrode plate. The negative electrode plate includes a negative current collector and a negative active material layer coated on the negative current collector. The negative active material layer includes the negative active material according to the embodiments of the present disclosure in the first aspect.

In a third aspect, the embodiments of the present disclosure provide a battery. The battery includes a housing and an electrode assembly disposed in the housing. The electrode assembly includes a negative electrode plate and a positive electrode plate. The negative electrode plate is the negative electrode plate according to the embodiments of the present disclosure in the second aspect.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

The present disclosure aims at solving at least one of the technical problems existing in the related art. To this end, an object of the present disclosure is to provide a negative active material having good dynamic performance. Therefore, a battery employing the negative active material can have good cycle performance and thus can have a higher cycle capacity retention rate at a later cycle stage, thereby prolonging a cycle service life of the battery.

In a first aspect, embodiments of the present disclosure provide a negative active material. The negative active material includes graphite. A specific surface area of the negative active material before a compaction process on the negative active material is X₁. A specific surface area of the negative active material after the compaction process is X₂. An orientation index of the negative active material before the compaction process is OIₐ. The negative active material satisfies 0.05<(X₂−X₁)/OIₐ<0.5, where X₁ and X₂ are in units of m²/g.

The graphite can be natural graphite or artificial graphite.

In an embodiment of the present disclosure, particles of the negative active material may include primary particles, secondary particles, or carbon-coated single particles.

In an embodiment of the present disclosure, parameters for the compaction process on the negative active material may include a pressure ranging from 0.5 T to 10 T and a pressing duration ranging from 10 seconds to 100 seconds. During the compaction of the negative active material, the pressure can range from 0.5 T to 10 T, and the pressure time can range from 10 seconds to 100 seconds. The negative active material can be compacted with the parameters for the compaction process and tested for the specific surface area X₂ of the negative active material. For example, the pressure may be 0.5 T, 1 T, 2 T, 3 T, 4 T, 5 T, 6 T, etc., and the pressing duration may be 10 seconds, 20 seconds, 30 seconds, 40 seconds, 50 seconds, 60 seconds, 70 seconds, 80 seconds, etc.

The specific surface area of the negative active material can be obtained by BET specific surface area test.

In the present disclosure, the negative active material is in powder form, and the powdery negative active material can be a negative active material separated from the negative electrode plate. For example, the negative electrode material may be directly scraped from the negative electrode plate, and then the negative active material may be extracted from the negative electrode material scraped from the negative electrode plate. The negative active material may be ground into powder. The specific surface area of the ground negative active material may be tested as X₁ before a compaction process on the negative active material, and the specific surface area of the ground negative active material may be tested as X₂ after the compaction process.

The above negative active material of the present disclosure may further be a powder raw material of the negative active material. The specific surface area of the powder raw material of the negative active material is tested as X₁ before a compaction process on the negative active material, and the specific surface area of the powder raw material of the negative active material is tested as X₂ after the compaction process.

It should be noted that the “compaction” described in the embodiments of the present disclosure refers to a compaction of powder.

During compressing and compacting the powdery negative active material, a porosity between the powder is relatively high at an initial compression stage. With a progress of compression, powder particles will undergo rearrangement and slip, and finally form a relatively dense accumulation state, and thus the porosity between the particles decreases. With the continuous increase of pressure, the powder particles will undergo elastic deformation. The porosity between the particles will not change much, but a pore diameter will decrease. With a further increase in pressure, a part of the powder will undergo irrecoverable plastic deformation, and the pore diameter will be further reduced. At the same time, a part of the particles may be broken, and the pore diameter may be more significantly reduced. A main reason for a change in the specific surface area of the negative active material powder before and after the compaction process is in that some particles may be crushed during the compaction, which results in an increase in the specific surface area of the negative active material after the compaction process, compared to the specific surface area of the negative active material before the compaction process.

An OI of the negative active material represents an orientation index of the negative active material. The OI of the negative active material can be obtained by X-ray diffraction (XRD) testing. For example, the negative active material before the compaction process can be taken for the XRD test to obtain the OIₐ of the negative active material before the compaction process. In the XRD test, the orientation of the negative active materials is described by a ratio of an intensity (or integrated area) of (004) diffraction peak to an intensity (or integrated area) of (110) diffraction peak, which is described by OI=C(004)/C(110).

For example, when the above negative active material is used for a negative electrode plate of a lithium ion battery, the negative active material includes a graphite material with a layered structure. An arrangement direction (orientation) of the layered structure has a great influence on migration or diffusion of lithium ions. When the OI of the negative active material is smaller, the graphite is less directionally selective in a lithium intercalation process, which improves a diffusion rate of lithium ions, thus improving the dynamics.

X₂−X₁ represents an increase in the specific surface area of the negative active material from the specific surface area before the compaction process to the specific surface area after the compaction process. A greater increase in the specific surface area of the negative active material from the specific surface area before the compaction process to the specific surface area after the compaction process is favorable to the improvement of the compaction density of the negative active material. Thus, it is more favorable to the increase of the energy density. An excessively great value of X₂−X₁ may also lead to an increase in side reactions of the negative active material in the negative electrode plate, thereby affecting high temperature performance.

According to the present disclosure, the ratio of X₂−X₁ to OIₐ is limited within a certain range. In this way, the negative active material before the compaction process can have a smaller OIₐ, while taking other performances of the negative active material into consideration. Meanwhile, by limiting the increase in the specific surface area of the negative active material before and after the compaction process, the negative active material can have higher compaction density, better dynamic performance, and high temperature performance. In this way, the battery employing the negative active material can have a higher cycle capacity retention rate at the later cycle stage. Therefore, the battery can have better cycle performance, prolonging the cycle service life of the battery.

For the negative active material according to the embodiments of the present disclosure, by controlling the ratio of the variation in the specific surface area before and after the compaction process of the negative active material to the orientation index OIₐ before the compaction process of the negative active material within a certain range, the negative active material can have better dynamic performance. Therefore, a battery employing the negative active material can have good cycle performance and thus can have a higher cycle capacity retention rate at a later cycle stage, thereby prolonging the cycle service life of the battery.

According to some embodiments of the present disclosure, the orientation index OIₐ of the negative active material before the compaction process is smaller than 10. By controlling the OIₐ of the negative active material before the compaction process to be in a range smaller than 10, the negative active material before the compaction process can have a small OIₐ, such that the negative active material can have better dynamic performance.

According to some optional embodiments of the present disclosure, the orientation index OIₐ of the negative active material before the compaction process ranges from 2 to 8. For example, OIₐ may have a value of 2, 3, 4, 5, 6, 7, or 8, etc. By controlling the OIₐ of the negative active material before the compaction process within the range from 2 to 8, the negative active material before the compaction process can have a small OIₐ, and thus it can have better dynamic performance, while taking other performances of the negative active material into consideration. Therefore, the overall performance of the negative active material can be enhanced.

According to some embodiments of the present disclosure, the X₂−X₁ satisfies 0.4 m²/g≤X₂−X₁≤1.5 m²/g. For example, the X₂−X₁ may be 0.4 m²/g, 0.6 m²/g, 0.8 m²/g, 1.0 m²/g, 1.2 m²/g, 1.4 m²/g, 1.5 m²/g, etc. By controlling the specific surface area increment of the negative active material before and after the compaction process within the range from 0.4 m²/g to 1.5 m²/g, a particle size of the negative active material can be controlled within an appropriate range. In this way, a problem of adverse dynamic performance caused by excessively great particle size of the negative active material and problem of low compaction density caused by excessively small particle size of the negative active material can be avoided, enabling the negative active material to have higher compaction density. Therefore, the energy density can be improved, and the negative active material can have better dynamic performance, thereby having improved cycle performance.

According to some embodiments of the present disclosure, X₁ ranges from 1.3 m²/g to 2.1 m²/g. For example, X₁ can be 1.3 m²/g, 1.5 m²/g, 1.7 m²/g, 1.9 m²/g, 2.1 m²/g, etc. According to some embodiments of the present disclosure, X₂ ranges from 1.7 m²/g to 3.6 m²/g. For example, X₂ can be 1.7 m²/g, 2.0 m²/g, 2.3 m²/g, 2.6 m²/g, 2.9 m²/g, 3.2 m²/g, 3.6 m²/g, etc. By controlling the specific surface area X₁ of the negative active material before the compaction process within the range from 1.3 m²/g to 2.1 m²/g and the specific surface area X₂ of the negative active material after the compaction process within the range from 1.7 m²/g to 3.6 m²/g, the particle size of the negative active material can be controlled in an appropriate range, enabling the negative active material to have better dynamic performance and higher energy density.

According to some embodiments of the present disclosure, the negative active material has a capacity per gram ranging from 340 mAh/g to 353 mAh/g. By controlling the capacity per gram of the negative active material within the range from 340 mAh/g to 353 mAh/g, the negative active material can have a higher energy density, and the negative active material can be controlled in an appropriate range to have better dynamic performance.

According to some embodiments of the present disclosure, the negative active material has a graphitization degree ranging from 92% to 95%. The graphization degree can control an interlayer spacing of the negative active material. With a decreasing of graphization degree of the negative active material, the microstructure of the negative active material is more irregular. Therefore, an overall interlayer spacing of the negative active material is larger, facilitating lithium ions to pass through the negative active material, thereby improving the diffusion rate of lithium ions and having better dynamic performance. With an increasing of the graphization degree of the negative active material, the microstructure of the negative active material is more regular, such that the interlayer spacing of the negative active material is smaller and the diffusion rate of lithium ions is smaller, leading to a deterioration of the dynamic performance.

A low graphitization degree is beneficial to improve the dynamic performance of the negative active materials, but a low graphitization degree may lead to a low capacity per gram and reduce the energy density of the battery. By controlling the graphization degree of the negative active material within the range from 92% to 95%, the negative active material has better dynamic performance and higher energy density.

In a second aspect, the negative electrode plate according to embodiments of the present disclosure includes a negative current collector and a negative active material layer coated on the negative current collector. The negative active material layer includes the negative active material according to the embodiments of the present disclosure in the first aspect.

For the negative electrode plate according to the embodiments of the present disclosure, as the negative active material is included in the negative active material layer of the negative electrode plate, the negative active material layer can have better dynamic performance. Therefore, the battery employing the negative electrode plate can have a higher cycle capacity retention rate at a later cycle stage, which enables the battery to have good cycle performance, thereby prolonging the cycle service life of the battery.

According to some embodiments of the present disclosure, the negative active material layer has an orientation index OI_{b}. The negative electrode plate satisfies 0.04≤(X₂−X₁)/OI_{b}≤0.1. For example, the OI_{b} may be 0.04, 0.05, 0.06, 0.07, 0.08, 0.09, 0.1, etc.

The orientation index OI_{b} of the negative active material layer represents the orientation index of the negative active material layer. A mixture composed of a powdery negative active material, a binder, and a conductive agent is coated on the negative current collector. The negative electrode plate is obtained by rolling. The substance composed of the powdery negative active material, the binder, and the conductive agent is formed as the negative active material layer covering the negative current collector by rolling.

The orientation index OI_{b} of the negative active material layer can be obtained by XRD test. The negative electrode plate after rolling is taken for performing XRD test on the negative active material layer covered on the negative current collector, to obtain the orientation index OI_{b} of the negative active material layer. An orientation of the negative electrode plate is described by a ratio of the intensity (or integrated area) of (004) diffraction peak to the intensity (or integrated area) of (110) diffraction peak, which is described by OI=C(004)/C(110). A smaller orientation index OI_{b} of the negative active material layer indicates that the layered structure of the negative active material tends to be perpendicular to the negative current collector, which is more conducive to the diffusion of lithium ions. In order to take other performances of the negative electrode plate into consideration, for example, taking the high temperature performance of the negative electrode plate into consideration, the orientation index OI_{b} of the negative active material layer cannot be infinitely small.

By further controlling a range of the ratio of X₂−X₁ to OI_{b}, lithium ions can be more easily embedded into the negative active material layer of the negative electrode plate, and the dynamic performance of the negative electrode plate can be further improved, thereby enabling the battery to have better dynamic performance and high temperature performance. When a ratio of X₂−X₁ to OI_{b} is smaller than 0.04, lithium ions can hardly be embedded into the negative active material layer of the negative electrode plate, which affects the dynamic performance of the negative electrode plate. When a ratio of X₂−X₁ to OI_{b} is greater than 0.1, the negative active material layer of the negative electrode plate has a poor wetting performance, which affects the cycle performance of the battery.

In a third aspect, the battery according to the embodiments of the present disclosure, the battery includes a housing and an electrode assembly disposed in the housing. The electrode assembly includes a negative electrode plate and a positive electrode plate. A separator is disposed between the negative electrode plate and the positive electrode plate. The negative electrode plate is the negative electrode plate according to the embodiments of the present disclosure in the second aspect.

In an embodiment of the present disclosure, the battery may be a lithium ion battery.

According to the battery of the embodiment of the present disclosure, by applying the negative electrode plate, the battery can have a higher cycle capacity retention rate at the later cycle stage. Therefore, the battery has better cycle performance, and the cycle service life of the battery can be prolonged.

The negative active material of the embodiments of the present disclosure will be further described below in conjunction with some examples and comparative examples.

Button batteries were prepared for testing. The button batteries of respective examples and comparative examples were prepared with a method, including preparation of a positive electrode plate, a negative electrode plate, an electrolyte, and a separator. The positive electrode plate, the positive electrode plate, the electrolyte, and the separator were prepared as follows.

Preparation of the positive electrode plate: the positive electrode active material, superconducting carbon black, and binder were mixed in a certain proportion to prepare a positive electrode slurry; and the positive electrode slurry was coated on a positive current collector (e.g., aluminum foil) and rolled, thereby obtaining a positive electrode plate.

Preparation of the negative electrode plate: the negative active material was made of artificial graphite; the negative active material, superconducting carbon black, and binder were mixed in a certain proportion to prepare a negative electrode slurry; and the negative electrode slurry was coated on the negative current collector (e.g., copper foil) and rolled, thereby obtaining a negative electrode plate.

Preparation of the electrolyte; lithium salt LiPF₆ was dissolved in an organic solvent to prepare an electrolyte.

Preparation of the separator: a polyethylene film of 12 m was selected.

The positive electrode plate, the separator, and the negative electrode plate were sequentially stacked in such a manner that the separator was located between the positive electrode plate and the negative electrode plate to isolate the positive electrode plate and the negative electrode plate. Thereafter, the electrolyte was added to assemble the button battery.

The button batteries of the respective examples and comparative examples were prepared with the above-mentioned preparation method. These button batteries differed from one another in the values of (X₂−X₁)/OIₐ of the negative active material layer and (X₂−X₁)/OI_{b} of the negative active material layer.

In the above negative electrode plate preparation process, the orientation index OIₐ of the negative active material before the compaction process has a certain influence on the orientation index of the negative active material layer OI_{b}, and thus the required OI_{b} can be obtained by controlling the OIₐ. A magnetic field induction technology may be introduced in a slurry coating process to artificially induce an arrangement of the negative active material on the negative electrode plate and change the OI_{b}. In a cold compressing process, the arrangement of the negative active material on the negative electrode plate can further be changed by adjusting the cold pressing process parameters such as cold pressing pressure and by adjusting the compaction density of the negative electrode plate, thereby changing the OI_{b}.

A cycle performance test was performed on the above-mentioned button batteries prepared in the examples and comparative examples: (1) at 25° C., the button batteries of the examples and comparative examples were discharged to 2.5 V at a rate of 1 C and charged to 3.65 V at a rate of 1 C, for performing full-charge discharge cycle test till 500 cycles, when capacity retention rates were recorded, thereby obtaining the cycle capacity retention rate at 25° C.; (2) at 45° C., the button batteries of examples and comparative examples were discharged to 2.5 V at a rate of 1 C and charged to 3.65 V at a rate of 1 C, for performing full charge discharge cycle test till 500 cycles, when capacity retention rates were recorded, thereby obtaining the cycle capacity retention rate at 45° C.

An electrochemical performance test was performed on the above-mentioned button batteries prepared in the examples and comparative examples. The electrochemical performance test was performed a test frequency ranging from 0.01 Hz to 10000 Hz, and charge transfer resistance was obtained through the electrochemical performance test.

After the cycle performance test and the electrochemical performance test of the above-mentioned button batteries prepared in the examples and comparative examples were completed, the negative electrode plate after rolling was taken for performing XRD test on the negative active material layer covered on the negative current collector, to obtain the orientation index OI_{b} of the negative active material layer.

Conditions for XRD test performed on the negative active material layer covered on the negative current collector were as follows: CuKα radiation was used as X-ray, and CuKα radiation was removed by a filter or a monochromator; a working voltage of X-ray tube ranged from 30 KV to 35 kV; a working current ranged from 15 mA to 20 mA; a scanning speed of a counter was ¼ (°)/min; a scanning range of a diffraction angle 20 ranged from 530 to 570 when recording diffraction line pattern of (004) crystal plane; and a scanning range of diffraction angle 2θ ranged from 75° to 79° when recording diffraction line pattern of (110) crystal plane.

Then, the negative active material was separated from the negative electrode plate to obtain the powdery negative active material. The XRD test was performed on the powdery negative active material to obtain the orientation index OIₐ before the compaction process. A BET testing was performed on the powdery negative active material before the compaction process and after the compaction process, respectively.

The negative active material was separated from the negative electrode plate by means of the following operations. The negative electrode plate was disassembled from the button battery. The negative electrode plate was soaked in dimethyl carbonate for a period to remove the electrolyte on the negative electrode plate. The negative electrode plate was placed in a blast oven for drying for later use. Then, a dried negative electrode plate was placed in a beaker, and pure water was added to separate the negative electrode material attached to the negative current collector from the negative current collector. The negative current collector was taken out. The beaker containing the negative electrode material was placed in an ultrasonic instrument for ultrasonic treatment for a period. Then the beaker was taken out to discard the turbid upper liquid layer, thereby removing auxiliary materials such as adhesive in the negative electrode material. The above ultrasonic treatment was repeated twice, and the beaker was placed in a ventilated place for standing. The turbid upper liquid layer was discarded, and the lower solid matter layer was placed on a watch dish, which was then placed in a blast oven for drying. Then, the dried solid matter was fully ground with a mortar. The ground solid matter was the negative active material.

The XRD test was performed on the powdery negative active material separated from the negative electrode plate before the compaction process. The powdery negative active material separated from the negative electrode plate and polycrystalline silicon were evenly mixed at a mass ratio of 7:3. By using high-purity silicon powder (purity 99.99%) as a standard sample, areas of C (004) peak and C (110) peak of the negative active material were tested, and the OIₐ was C(004)/C(110).

XRD test conditions for the powdery negative active material separated from the negative electrode plate were as follows: CuKα radiation was used as X-ray, and CuKα radiation was removed by a filter or a monochromator; a working voltage of X-ray tube ranged from 30 KV to 35 kV; a working current ranged from 15 mA to 20 mA; a scanning speed of a counter was ¼ (°)/min; a scanning range of a diffraction angle 20 ranged from 53° to 57° when recording diffraction line pattern of (004) crystal plane; and a scanning range of diffraction angle 20 ranged from 750 to 790 when recording diffraction line pattern of (110) crystal plane.

The BET test before and after the compaction process were as follows. The BET test was performed on the powdery negative active material separated from the negative electrode plate before the compaction process to obtain the specific surface area X₁ before the compaction process. The BET test was performed on the powdery negative active material separated from the negative electrode plate after powder compaction to obtain the specific surface area X₂ after the compaction process.

Conditions for powder compaction test of the negative active material were as follows. 1±0.05 g of a sample of the pre-treated negative electrode active material was weighed and tested using UTM7305/electronic pressure tester. Pressurized displacement control was 10 mm/min, and holding time was 30 seconds. Unpressurized displacement control was 30 mm/min, and holding time was 10 seconds. The test pressure was 5 T.

Data obtained from the cycle performance test, OI test, and BET test before and after the compaction process for the respective examples and comparative examples described above were shown in Table 1 below.

TABLE 1

| | | | | | | | | Charge | 45° C. | 25° C. |
|---|---|---|---|---|---|---|---|---|---|---|
| | | | | | | | | transfer | capacity | capacity |
| | X₁ | X₂ | X [symbol] − X [symbol] | OI [symbol] | | | | resistance | retention | retention |
| Serial number | (m²/g) | (m²/g) | (m²/g) | value | (X [symbol] − X [symbol] )/OI [symbol] | OI [symbol] | (X [symbol] − X [symbol] )/OI [symbol] | (Ω) | rate | rate |
| Example 1 | 1.95 | 2.53 | 0.58 | 2.6573 | 0.082 | 11.082 | 0.052 | 2.32 | 92.14% | 94.98% |
| Example 2 | 1.33 | 1.96 | 0.63 | 3.9827 | 0.158 | 10.368 | 0.061 | 2.42 | 95.54% | 95.82% |
| Example 3 | 1.65 | 2.49 | 0.84 | 4.4562 | 0.188 | 12.294 | 0 068 | 2.51 | 94.61% | 96.72% |
| Example 4 | 1.82 | 3.14 | 1.32 | 6.2742 | 0.210 | 13.492 | 0.098 | 2.68 | 93.72% | 95.91% |
| Example 5 | 1.97 | 3.23 | 1.26 | 5.0252 | 0.251 | 14.924 | 0.084 | 2.83 | 93.21% | 96.26% |
| Example 6 | 1.33 | 1.96 | 0.63 | 3.9827 | 0.158 | 13.114 | 0.042 | 2.46 | 93.19% | 95.89% |
| Example 7 | 1.33 | 1.96 | 0.63 | 3.9827 | 0.158 | 14.479 | 0.044 | 2.02 | 93.02% | 95.26% |
| Example 8 | 1.53 | 2.03 | 0.50 | 1.7730 | 0.282 | 7.8125 | 0.064 | 1.98 | 92.83% | 94.87% |
| Example 9 | 1.64 | 2.37 | 0.73 | 2.0798 | 0.351 | 10.1389 | 0.072 | 2.02 | 92 01% | 95.28% |
| Example 10 | 1.76 | 2.72 | 0.96 | 2.2069 | 0.435 | 20.4255 | 0.047 | 3.51 | 91.78% | 96.17% |
| Example 11 | 1.88 | 3.38 | 1.50 | 3.1743 | 0.473 | 25.9322 | 0.058 | 3.68 | 91.25% | 96.26% |
| Comparative | 1.25 | 1.59 | 0.34 | 8.0675 | 0.043 | 23.254 | 0.014 | 3.99 | 93.81% | 91.82% |
| example 1 | | | | | | | | | | |
| Comparative | 2.54 | 4.12 | 1.58 | 1.8936 | 0.657 | 15.201 | 0.104 | 3.23 | 92.14% | 87.55% |
| example 2 | | | | | | | | | | |

[symbol]

indicates data missing or illegible when filed

Table 1 indicates the following facts. When the value of (X₂−X₁)/OIₐ was between 0.05 and 0.5, the charge transfer resistance of the negative active material was relatively small, the dynamic performance of the negative active material was good, and the capacity retention rate at the later cycle stage was relatively high. When the value of (X₂−X₁)/OIₐ was smaller than 0.05, the charge transfer resistance of the negative active material was relatively great, the dynamic performance of the negative active material was poor, and the capacity retention rate at the later cycle stage was relatively low. When the value of (X₂−X₁)/OIₐ was greater than 0.5, the negative active material had a relatively great specific surface area and poor high temperature performance, and the high temperature cycle performance loss was faster.

When the value of (X₂−X₁)/OI_{b} was smaller than 0.04, it was difficult for lithium ions to embed into the negative electrode plate, which affects the dynamic performance of the negative electrode plate. When the value of (X₂−X₁)/OI_{b} was greater than 0.1, the negative electrode plate had a poor wetting performance, which affects the cycle performance of the battery.

In the specification, description with reference to the term such as “an embodiment”, “some embodiments”, “exemplary embodiments”, “examples” “specific examples”, or “some examples” means that specific features, structure, materials or characteristics described in conjunction with the embodiment or example are included in at least one embodiment or example of the present disclosure. In this specification, the schematic representations of the above terms do not necessarily refer to the same embodiment or example. Moreover, the described specific features, structures, materials or characteristics may be combined in any one or more embodiments or examples in a suitable manner.

Although the embodiments of the present disclosure have been illustrated and described, it is conceivable for those of ordinary skill in the art that various changes, modifications, replacements, and variations can be made to these embodiments without departing from the principles and spirit of the present disclosure. The scope of the present disclosure shall be defined by the claims as appended and their equivalents.

What is claimed is:

1. A negative active material, comprising graphite, wherein:
a specific surface area of the negative active material before a compaction process on the negative active material is X₁;
a specific surface area of the negative active material after the compaction process is X₂;
an orientation index of the negative active material before the compaction process is OIₐ; and
the negative active material satisfies 0.05<(X₂−X₁)/OIₐ<0.5, where X₁ and X₂ are in units of m²/g.

2. The negative active material according to claim 1, wherein the orientation index OIₐ of the negative active material before the compaction process is smaller than 10.

3. The negative active material according to claim 2, wherein the orientation index OIₐ of the negative active material before the compaction process ranges from 2 to 8.

4. The negative active material according to claim 1, wherein X₂−X₁ satisfies 0.4 m²/g≤X₂−X₁≤1.5 m²/g.

5. The negative active material according to claim 1, wherein:
X₁ ranges from 1.3 m²/g to 2.1 m²/g; and
X₂ ranges from 1.7 m²/g to 3.6 m²/g.

6. The negative active material according to claim 1, wherein the negative active material has a capacity per gram ranging from 340 mAh/g to 353 mAh/g.

7. The negative active material according to claim 1, wherein the negative active material has a graphitization degree ranging from 92% to 95%.

8. The negative active material according to claim 1, wherein parameters for the compaction process on the negative active material comprise a pressure ranging from 0.5 T to 10 T and a pressing duration ranging from 10 seconds to 100 seconds.

9. A negative electrode plate, comprising:
a negative current collector; and
a negative active material layer coated on the negative current collector, the negative active material layer comprising a negative active material, the negative active material comprising graphite, wherein:
a specific surface area of the negative active material before a compaction process on the negative active material is X₁;
a specific surface area of the negative active material after the compaction process is X₂;
an orientation index of the negative active material before the compaction process is OIₐ; and
the negative active material satisfies 0.05<(X₂−X₁)/OIₐ<0.5, where X₁ and X₂ are in units of m²/g.

10. The negative electrode plate according to claim 9, wherein:
the negative active material layer has an orientation index OI_{b}; and
the negative electrode plate satisfies 0.04≤(X₂−X₁)/OI_{b}≤0.1.

11. The negative electrode plate according to claim 9, wherein the orientation index OIₐ of the negative active material before the compaction process is smaller than 10.

12. The negative electrode plate according to claim 11, wherein the orientation index OIₐ of the negative active material before the compaction process ranges from 2 to 8.

13. The negative electrode plate according to claim 9, wherein X₂−X₁ satisfies 0.4 m²/g≤X₂−X₁≤1.5 m²/g.

14. The negative electrode plate according to claim 9, wherein:
X₁ ranges from 1.3 m²/g to 2.1 m²/g; and
X₂ ranges from 1.7 m²/g to 3.6 m²/g.

15. The negative electrode plate according to claim 9, wherein the negative active material has a capacity per gram ranging from 340 mAh/g to 353 mAh/g.

16. The negative electrode plate according to claim 9, wherein the negative active material has a graphitization degree ranging from 92% to 95%.

17. The negative electrode plate according to claim 9, wherein parameters for the compaction process on the negative active material comprise a pressure ranging from 0.5 T to 10 T and a pressing duration ranging from 10 seconds to 100 seconds.

18. A battery, comprising:
a housing; and
an electrode assembly disposed in the housing, the electrode assembly comprising a negative electrode plate and a positive electrode plate, the negative electrode plate comprising:
a negative current collector; and
a negative active material layer coated on the negative current collector, the negative active material layer comprising a negative active material, the negative active material comprising graphite, wherein:
a specific surface area of the negative active material before a compaction process on the negative active material is X₁;
a specific surface area of the negative active material after the compaction process is X₂;
an orientation index of the negative active material before the compaction process is OIₐ; and
the negative active material satisfies 0.05<(X₂−X₁)/OIₐ<0.5, where X₁ and X₂ are in units of m²/g.

19. The battery according to claim 18, wherein the negative electrode plate layer has an orientation index of OI_{b}; and
the negative electrode plate satisfies 0.04≤(X₂−X₁)/OI_{b}≤0.1.
